(19) United States
(12) Patent Application Publication
(10) Pub. No.: US 2025/0334111 A1
(43) Pub. Date: Oct. 30, 2025

(54) ELECTRIC DRIVE FRACTURING DEVICE AND BRAKING METHOD THEREFOR

(71) Applicant: YANTAI JEREH PETROLEUM EQUIPMENT & TECHNOLOGIES CO., LTD., Yantai (CN)

(72) Inventors: Sheng CHANG, Yantai (CN); Chuanbo WANG, Yantai (CN); Liang LV, Yantai (CN); Shouzhe LI, Yantai (CN); Kaishen LIU, Yantai (CN); Mingzhao MAO, Yantai (CN)

(21) Appl. No.: 19/263,282

(22) Filed: Jul. 8, 2025

Related U.S. Application Data
(63) Continuation of application No. PCT/CN2024/071326, filed on Jan. 9, 2024.

(30) Foreign Application Priority Data
Jan. 9, 2023 (CN) 202310023885.6

(51) Int. Cl. F04B 49/03; E21B 43/26; F04B 17/03; F04B 19/04; F16D 55/22; F16D 65/18; F16K 31/02; H02P 3/02

(52) U.S. Cl. CPC F04B 49/03; E21B 43/2607; F04B 17/03; F04B 19/04; F16D 55/22; F16D 65/18; F16K 31/02; H02P 3/02; F04B 2205/04

(57) ABSTRACT

An electric drive fracturing device and a braking method therefor are provided. The electric drive fracturing device includes an electric drive fracturing device body and a braking system. The electric drive fracturing device body includes a plunger pump and a control system. The braking system includes a brake trigger component and a brake execution component. The brake trigger component transmits a brake signal to the control system, and after receiving the brake signal transmitted by the brake trigger component, the control system controls the brake execution component to perform a braking action to stop the plunger pump. In the present invention, a braking system is arranged in the electric drive fracturing device, so that rapid braking of the electric drive fracturing device can be implemented, and emergency braking can be performed immediately when a problem such as bursting of a high-pressure manifold system occurs on site.

### CROSS-REFERENCE TO RELATED APPLICATIONS

This application is a continuation of International Application No. PCT/CN2024/071326 filed on Jan. 9, 2024, which claims priority to and benefits of Chinese Patent Application No. 202310023885.6, filed with the China National Intellectual Property Administration on Jan. 9, 2023. The content of all of the above-referenced applications is incorporated herein by reference in their entirety.

### TECHNICAL FIELD

The present invention relates to an electric drive fracturing device and a braking method therefor, and belongs to the field of electric drive fracturing device manufacturing technologies.

### BACKGROUND

Fracturing is an important measure to increase production and efficiency during oil extraction, and its main function is to enhance permeability of oil layers. A key device during a fracturing operation is a fracturing device. Currently, existing fracturing devices include a diesel-driven fracturing device and an electric drive fracturing device. Due to increasingly high requirements for environmental protection and shortcomings of the diesel-driven fracturing device, such as a large floor area, a heavy weight, inconvenient transportation, loud noise, no environmental protection, and high operating costs, the electric drive fracturing device has been used as a main fracturing device in a fracturing operation.

The electric drive fracturing device drives a plunger pump into motion through an electric motor as a power source. An operating medium of the fracturing operation is suctioned into a manifold system (a low-pressure manifold system) through the plunger pump, discharged through a discharge manifold system (a high-pressure manifold system) after being pressurized by the plunger pump, and injected into a well through a ground manifold system to implement the fracturing operation. The fracturing operation in which the electric drive fracturing device participates belongs to a high-pressure operation. When a problem such as bursting occurs in the high-pressure manifold system, if the device cannot be shut down quickly at the first time, the operating medium may be discharged to a well site through the burst high-pressure manifold system, resulting in environmental pollution and a waste of operating media. However, most of the operating media in the fracturing operation contain chemical agents or acidic media, which makes the operating medium corrosive. Once the operating medium is sprayed onto a constructor, an accident such as personal injury may be caused. Currently, the electric drive fracturing device is not equipped with a braking system, which results in the inability to achieve a rapid emergency shutdown at the first time when the above high-pressure manifold system bursts, causing problems such as well site pollution, material waste, and personal injury accidents.

### SUMMARY

The technical problem resolved by the present invention is to provide an electric drive fracturing device and a braking method therefor in view of the shortcomings of the related art. A braking system is arranged in the electric drive fracturing device, so that rapid braking of the electric drive fracturing device can be implemented, and emergency braking can be performed immediately when a problem such as bursting of a high-pressure manifold system occurs on site, to avoid greater safety hazards and reduce environmental pollution and material waste. Further, through a frequency converter provided with a brake battery, it is also possible to recycle and utilize the braking energy while achieving braking.

The present invention provides an electric drive fracturing device, including an electric drive fracturing device body and a braking system. The electric drive fracturing device body includes an electric motor, a plunger pump, a high-pressure manifold system, a low-pressure manifold system, a hydraulic end lubrication system, a power end lubrication system, a cooling system, and a control system. The braking system includes a brake trigger component and a brake execution component. The brake trigger component and the brake execution component are both electrically connected to the control system, the brake trigger component transmits a brake signal to the control system, and after receiving the brake signal transmitted by the brake trigger component, the control system controls the brake execution component to perform a braking action to stop the plunger pump.

Preferably, the brake execution component is a high-pressure shutoff valve arranged in the high-pressure manifold system.

Preferably, the high-pressure shutoff valve is electrically, hydraulically, or pneumatically closed and opened, and the high-pressure shutoff valve is configured to be closed after receiving the brake signal.

Preferably, the high-pressure shutoff valve is in a normally open state or a normally closed state.

Preferably, the brake execution component is a shutoff valve arranged in the low-pressure manifold system.

Preferably, the shutoff valve is electrically, hydraulically, or pneumatically closed and opened, and the shutoff valve is configured to be closed after receiving the brake signal.

Preferably, the shutoff valve is in a normally open state or a normally closed state.

Preferably, the brake execution component is a brake caliper and a brake disc, and the brake disc is arranged on an output shaft of the electric motor or an input shaft of the plunger pump.

Preferably, the brake caliper is driven electrically, hydraulically, or pneumatically, and the brake caliper is configured to clamp and rub the brake disc after receiving the brake signal.

Preferably, the brake caliper is a normally open brake caliper or a normally closed brake caliper.

To further realize braking, the control system further controls the electric motor to stop power output after receiving the brake signal transmitted by the brake trigger component.

Preferably, the brake execution component is a frequency converter, and a brake resistor or a brake battery is arranged inside or outside the frequency converter.

Preferably, the control system transmits the brake signal to the frequency converter after receiving the brake signal transmitted by the brake trigger component, the frequency converter controls the electric motor to stop power output after receiving the brake signal, and charges the brake battery, or the brake resistor absorbs energy and converts the energy into heat energy.

Preferably, the brake execution component includes one or more of a high-pressure shutoff valve arranged in the high-pressure manifold system, a shutoff valve arranged in the low-pressure manifold system, a brake caliper, a brake disc, and a frequency converter.

To determine braking timing, the brake trigger component includes a pressure sensor arranged in the high-pressure manifold system or the plunger pump, and the pressure sensor is configured to perform real-time detection on a fluid pressure at a discharge end of the plunger pump. Alternatively, the brake trigger component includes a camera, and the camera is configured to perform real-time detection on images of the plunger pump and the high-pressure manifold system.

Preferably, the brake trigger component transmits a brake signal to the control system when the fluid pressure exceeds a set threshold or when a puncture occurs in the plunger pump or the high-pressure manifold system.

The present invention further provides a braking method for an electric drive fracturing device, applied to the foregoing electric drive fracturing device. The braking method includes:
performing, by the brake trigger component, real-time detection on the fluid pressure at the discharge end of the plunger pump and/or images of the plunger pump and the high-pressure manifold system;
transmitting a brake signal to the control system when the fluid pressure exceeds a set threshold or when a puncture occurs in the plunger pump or the high-pressure manifold system; and
controlling, by the control system after receiving the brake signal transmitted by the brake trigger component, the brake execution component to perform a braking action to stop the plunger pump.

Based on the above, in the present invention, a braking system is arranged in the electric drive fracturing device, so that rapid braking of the electric drive fracturing device can be implemented, and emergency braking can be performed immediately when a problem such as bursting of a high-pressure manifold system occurs on site, to avoid greater safety hazards and reduce environmental pollution and material waste. Further, through a frequency converter provided with a brake battery, it is also possible to recycle and utilize the braking energy while achieving braking.

Technical solutions of the present invention are described in detail below with reference to the accompanying drawings and specific embodiments.

### BRIEF DESCRIPTION OF THE DRAWINGS

FIG. 1 is a schematic block diagram of an electric drive fracturing device according to the present invention.

FIG. 2 is an operating principle diagram of a brake trigger component according to the present invention.

FIG. 3 is a schematic block diagram of an electric drive fracturing device according to Embodiment I of the present invention.

FIG. 4 is a first operating principle diagram of an electric drive fracturing device according to Embodiment I of the present invention.

FIG. 5 is a second operating principle diagram of an electric drive fracturing device according to Embodiment I of the present invention.

FIG. 6 is a third operating principle diagram of an electric drive fracturing device according to Embodiment I of the present invention.

FIG. 7 is a fourth operating principle diagram of an electric drive fracturing device according to Embodiment I of the present invention.

FIG. 8 is a fifth operating principle diagram of an electric drive fracturing device according to Embodiment I of the present invention.

FIG. 9 is a sixth operating principle diagram of an electric drive fracturing device according to Embodiment I of the present invention.

FIG. 10 is a schematic block diagram of an electric drive fracturing device according to Embodiment II of the present invention.

FIG. 11 is a first operating principle diagram of an electric drive fracturing device according to Embodiment II of the present invention.

FIG. 12 is a second operating principle diagram of an electric drive fracturing device according to Embodiment II of the present invention.

FIG. 13 is a third operating principle diagram of an electric drive fracturing device according to Embodiment II of the present invention.

FIG. 14 is a fourth operating principle diagram of an electric drive fracturing device according to Embodiment II of the present invention.

FIG. 15 is a fifth operating principle diagram of an electric drive fracturing device according to Embodiment II of the present invention.

FIG. 16 is a sixth operating principle diagram of an electric drive fracturing device according to Embodiment II of the present invention.

FIG. 17 is a schematic diagram of a brake execution component according to Embodiment III of the present invention.

FIG. 18 is a first operating principle diagram of an electric drive fracturing device according to Embodiment III of the present invention.

FIG. 19 is a second operating principle diagram of an electric drive fracturing device according to Embodiment III of the present invention.

FIG. 20 is a third operating principle diagram of an electric drive fracturing device according to Embodiment III of the present invention.

FIG. 21 is a fourth operating principle diagram of an electric drive fracturing device according to Embodiment III of the present invention.

FIG. 22 is a fifth operating principle diagram of an electric drive fracturing device according to Embodiment III of the present invention.

FIG. 23 is a sixth operating principle diagram of an electric drive fracturing device according to Embodiment III of the present invention.

FIG. 24 is a first operating principle diagram of an electric drive fracturing device according to Embodiment IV of the present invention.

FIG. 25 is a second operating principle diagram of an electric drive fracturing device according to Embodiment IV of the present invention.

### DETAILED DESCRIPTION

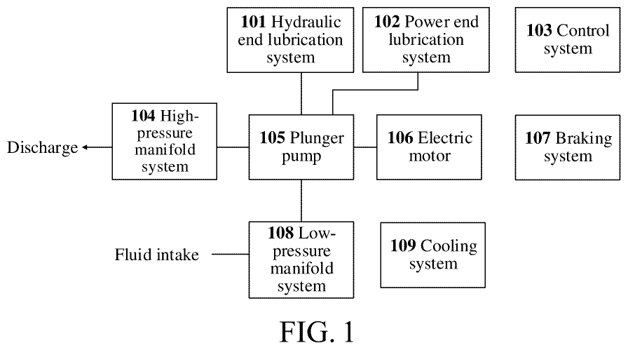

The present invention provides an electric drive fracturing device and a braking method therefor. FIG. 1 is a schematic block diagram of an electric drive fracturing device according to the present invention. As shown in FIG. 1, the electric drive fracturing device includes an electric drive fracturing device body and a braking system 107. A driving principle of the electric drive fracturing device is that an electric motor 106 is used as a power source to drive a plunger pump 105 into motion through a transmission shaft. The electric drive fracturing device body includes but is not limited to an electric motor 106, a plunger pump 105, a high-pressure manifold system 104, a low-pressure manifold system 108, a hydraulic end lubrication system 101, a power end lubrication system 102, a cooling system 109, and a control system 103. Each component of the electric drive fracturing device may be placed on a chassis vehicle, a semi-trailer, or a steel structure skid frame, so as to facilitate transportation and transfer of a device. The electric drive fracturing device body is the existing technology, and therefore details are not described herein again.

The braking system 107 includes a brake trigger component and a brake execution component. The brake trigger component and the brake execution component are both electrically connected to the control system 103, the brake trigger component transmits a brake signal to the control system 103, and after receiving the brake signal transmitted by the brake trigger component, the control system 103 transmits the brake signal to the brake execution component, and controls the brake execution component to perform a braking action to stop the plunger pump 105.

It should be supplemented that the control system 103 may further control the electric motor 106 to stop power output after receiving the brake signal transmitted by the brake trigger component.

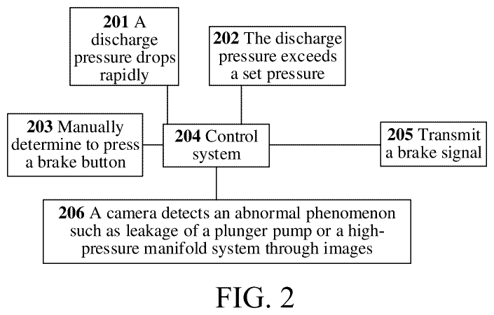

FIG. 2 is an operating principle diagram of a brake trigger component according to the present invention. In this embodiment, the brake trigger component may include a pressure sensor arranged in a high-pressure manifold system or a plunger pump. The pressure sensor is configured to perform real-time detection on a fluid pressure at a discharge end of the plunger pump. When the fluid pressure (a discharge pressure) exceeds a set threshold (for example, when the fluid pressure in a high-pressure manifold of the plunger pump exceeds a set pressure during an actual operation at 202 or when the fluid pressure at the discharge end of the plunger pump drops rapidly during an actual operation at 201), the brake trigger component transmits a brake signal at 205 to the control system 204. Alternatively, the brake trigger component may include a camera. The camera is configured to perform real-time detection on images of the plunger pump and the high-pressure manifold system. The camera transmits a brake signal to the control system 204 when detecting that an abnormal phenomenon such as leakage of the plunger pump or the high-pressure manifold system occurs through the images at 206. Alternatively, the brake trigger component may be manually operated. For example, the brake trigger component is a brake button arranged on the control system 204, and when it is manually determined that a braking action is needed at 203, the control system 204 is enabled by pressing the brake button to control the brake execution component to perform a braking action.

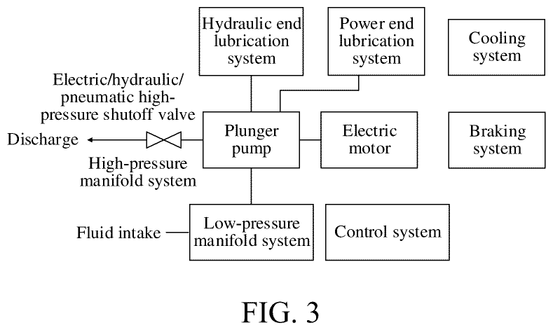

FIG. 3 is a schematic block diagram of an electric drive fracturing device according to Embodiment I of the present invention. As shown in FIG. 3, in Embodiment I, a brake execution component is a high-pressure shutoff valve 301 arranged in a high-pressure manifold system 302. The high-pressure shutoff valve 301 may be a high-pressure plug valve, a high-pressure gate plate, or another high-pressure shutoff component. The high-pressure shutoff valve 301 may be closed and opened electrically, hydraulically, or pneumatically.

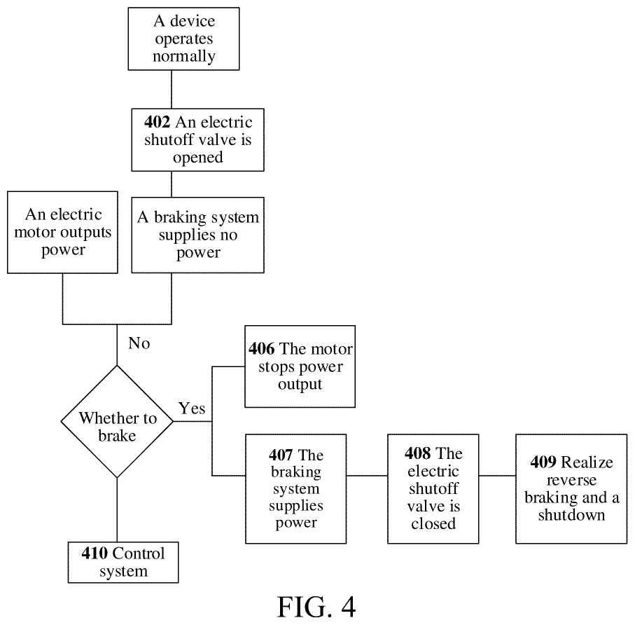

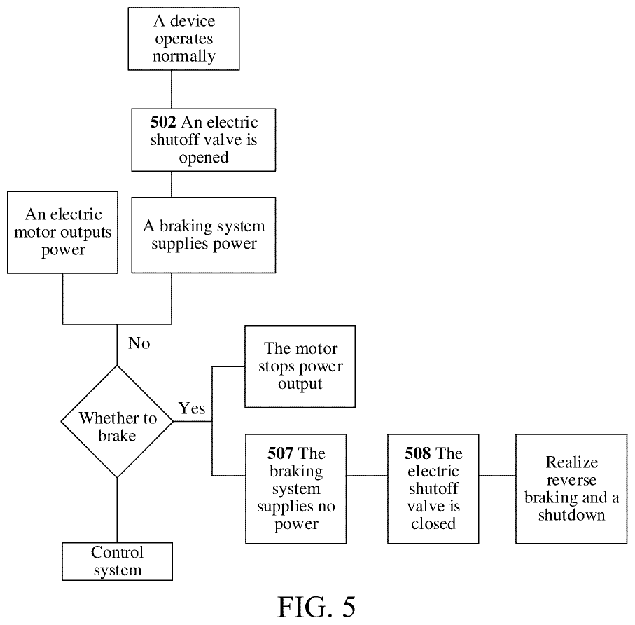

FIG. 4 is a first operating principle diagram of an electric drive fracturing device according to Embodiment I of the present invention, and FIG. 5 is a second operating principle diagram of an electric drive fracturing device according to Embodiment I of the present invention. When the high-pressure shutoff valve adopts an electric drive mode (an electric shutoff valve), a power source may be provided by an internal power supply of an electric drive fracturing device body or by an external power supply. When a braking action needs to be performed, the control system 410 controls, after receiving the brake signal transmitted by the brake trigger component, the brake execution component (the high-pressure shutoff valve) to perform a braking action to stop the plunger pump. It should be supplemented that the control system 410 may further control the electric motor to stop power output at 406 after receiving the brake signal transmitted by the brake trigger component. Specifically, an electric motor driving the plunger pump stops power output at 406. In this case, the plunger pump and the electric motor run by inertia, and at the same time, the high-pressure shutoff valve starts to operate after receiving the brake signal. The high-pressure shutoff valve is closed at 408, so that an outlet of the high-pressure manifold of the plunger pump is blocked by the high-pressure shutoff valve, resulting in that the liquid inside the plunger pump cannot be normally discharged. The liquid generates a reverse acting force on the plunger pump and reversely brakes the plunger pump to stop its movement, thereby finally realizing a brake shutdown at 409. After receiving a shutdown feedback, the control system 410 disables brake command output.

A difference between the electric drive fracturing devices shown in FIG. 4 and FIG. 5 is that in the electric drive fracturing device shown in FIG. 4, the high-pressure shutoff valve is in a normally open state (a normally open shutoff valve) at 402, that is, the high-pressure shutoff valve changes from an open state at 402 to a closed state at 408 when power is supplied at 407. In the electric drive fracturing device shown in FIG. 5, the high-pressure shutoff valve is in a normally closed state (a normally closed shutoff valve) at 508, that is, the high-pressure shutoff valve changes from an open state at 502 to a closed state at 508 when no power is supplied at 507. A person skilled in the art may select a design based on an actual requirement.

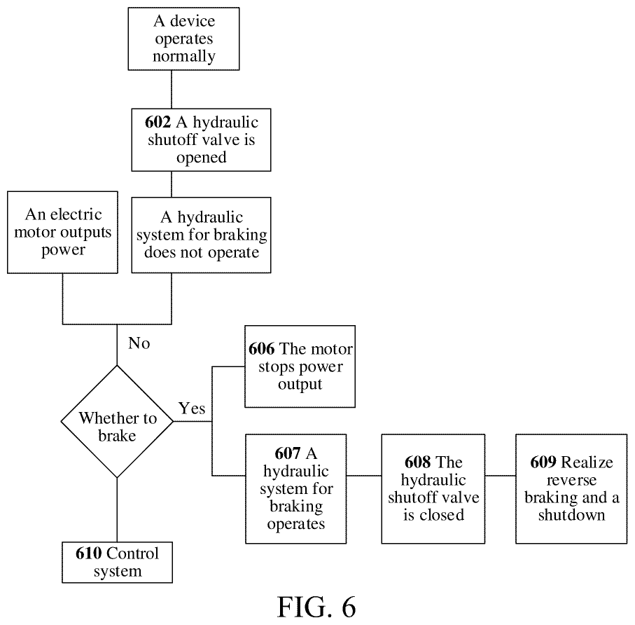

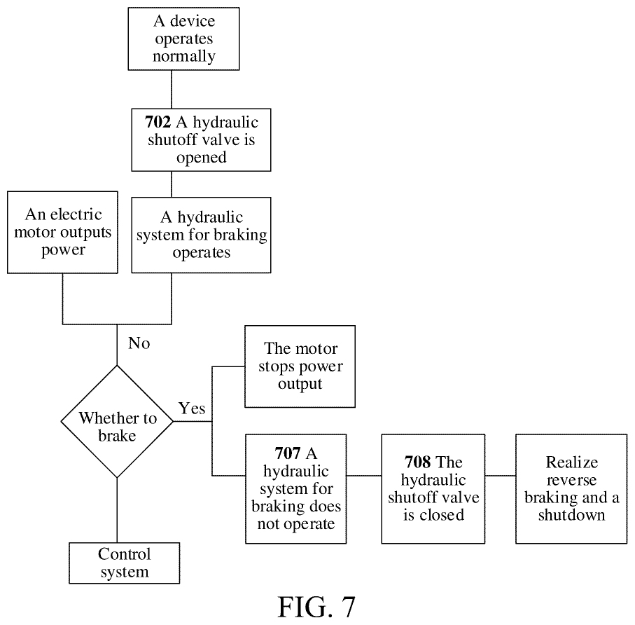

FIG. 6 is a third operating principle diagram of an electric drive fracturing device according to Embodiment I of the present invention, and FIG. 7 is a fourth operating principle diagram of an electric drive fracturing device according to Embodiment I of the present invention. When a high-pressure shutoff valve adopts a hydraulic drive mode (a hydraulic shutoff valve), hydraulic power may come from a hydraulic system mounted in the electric drive fracturing device body, or may come from a hydraulic system outside the electric drive fracturing device.

The hydraulic system mounted in the electric drive fracturing device body may use an existing hydraulic system, for example, including a hydraulic oil tank, a hydraulic pump, a drive motor of a hydraulic pump, and a filter element. A power source of the drive motor of the hydraulic pump is provided by an internal power supply of the electric drive fracturing device body or by an external power supply. When a braking action needs to be performed, the control system 610 controls, after receiving the brake signal transmitted by the brake trigger component, the brake execution component (the high-pressure shutoff valve) to perform a braking action to stop the plunger pump. It should be supplemented that the control system 610 may further control the electric motor to stop power output at 606 after receiving the brake signal transmitted by the brake trigger component. Specifically, an electric motor driving the plunger pump stops power output at 606. In this case, the plunger pump and the electric motor run by inertia, and at the same time, the hydraulic system operates to provide hydraulic power (or stops providing hydraulic power). The high-pressure shutoff valve operates to realize closing at 608, so that an outlet of the high-pressure manifold of the plunger pump is blocked by the high-pressure shutoff valve, resulting in that the liquid inside the plunger pump cannot be normally discharged. The liquid generates a reverse acting force on the plunger pump and reversely brakes the plunger pump to stop its movement, thereby finally realizing a braking function at 609. After receiving a shutdown feedback, the control system 610 disables brake command output.

When the hydraulic power comes from a hydraulic system outside the electric drive fracturing device, a valve is arranged between the hydraulic system and the high-pressure shutoff valve of the electric drive fracturing device. When a braking action is needed, the control system 610 controls the valve between the external hydraulic power source and the high-pressure shutoff valve to open (or close) after receiving the brake signal transmitted by the brake trigger component, and the external hydraulic power source provides hydraulic power to the high-pressure shutoff valve (or stops providing power). The high-pressure shutoff valve operates to realize closing at 608, so that an outlet of the high-pressure manifold of the plunger pump is blocked by the high-pressure shutoff valve, resulting in that the liquid inside the plunger pump cannot be normally discharged. The liquid generates a reverse acting force on the plunger pump and reversely brakes the plunger pump to stop its movement, thereby finally realizing a braking function at 609. After receiving a shutdown feedback, the control system 610 disables brake command output.

A difference between the electric drive fracturing devices shown in FIG. 6 and FIG. 7 is that in the electric drive fracturing device shown in FIG. 6, the high-pressure shutoff valve is in a normally open state (a normally open shutoff valve) at 602, that is, the high-pressure shutoff valve changes from an open state at 602 to a closed state at 608 when the hydraulic system operates at 607. In the electric drive fracturing device shown in FIG. 7, the high-pressure shutoff valve is in a normally closed state (a normally closed shutoff valve) at 708, that is, the high-pressure shutoff valve changes from an open state at 702 to a closed state at 708 when the hydraulic system does not operate at 707. A person skilled in the art may select a design based on an actual requirement.

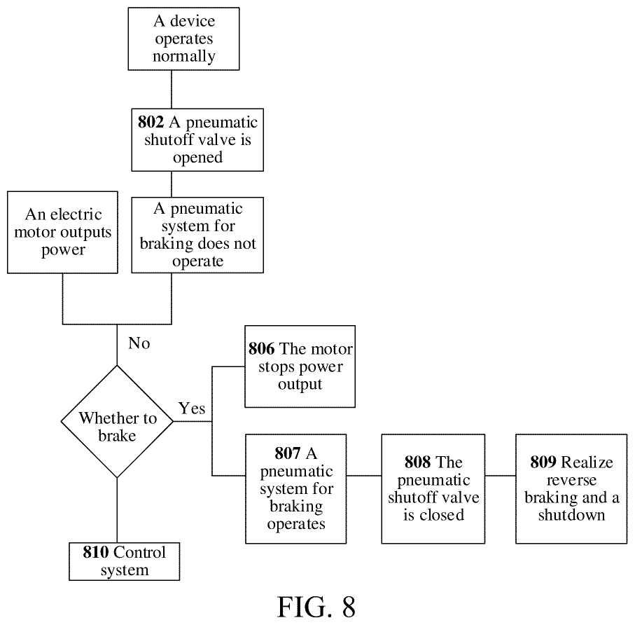

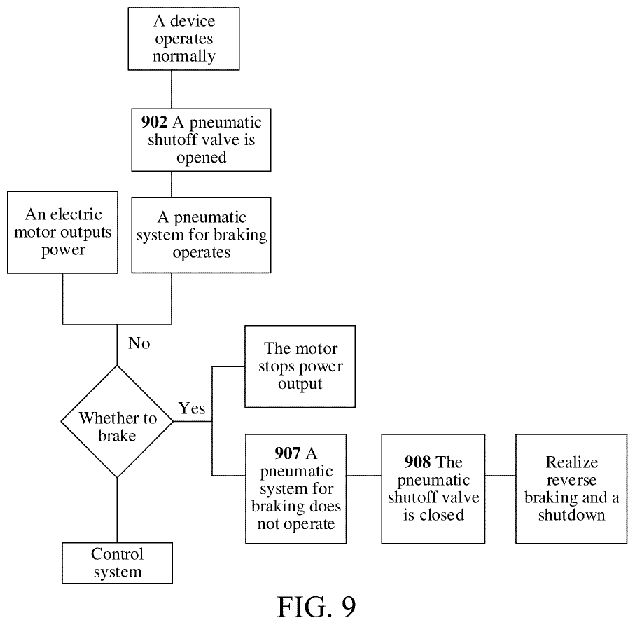

FIG. 8 is a fifth operating principle diagram of an electric drive fracturing device according to Embodiment I of the present invention, and FIG. 9 is a sixth operating principle diagram of an electric drive fracturing device according to Embodiment I of the present invention. When the high-pressure shutoff valve adopts a pneumatic drive mode (a pneumatic shutoff valve), pneumatic power may come from a pneumatic system mounted in the electric drive fracturing device body, or may come from a pneumatic system outside the electric drive fracturing device.

When a braking action is needed, the control system 810 controls, after receiving the brake signal transmitted by the brake trigger component, the brake execution component (the high-pressure shutoff valve) to perform a braking action to stop the plunger pump. It should be supplemented that the control system 810 may further control the electric motor to stop power output at 806 after receiving the brake signal transmitted by the brake trigger component. Specifically, an electric motor driving the plunger pump stops power output at 806. In this case, the plunger pump and the electric motor run by inertia, and at the same time, the pneumatic system mounted in the electric drive fracturing device body or the pneumatic system outside the electric drive fracturing device provides pneumatic power (or stops providing pneumatic power). The high-pressure shutoff valve operates to realize closing at 808, so that an outlet of the high-pressure manifold of the plunger pump is blocked by the high-pressure shutoff valve, resulting in that the liquid inside the plunger pump cannot be normally discharged. The liquid generates a reverse acting force on the plunger pump and reversely brakes the plunger pump to stop its movement, thereby finally realizing a braking function at 809. After receiving a shutdown feedback, the control system 810 disables brake command output.

A difference between the electric drive fracturing devices shown in FIG. 8 and FIG. 9 is that in the electric drive fracturing device shown in FIG. 8, the high-pressure shutoff valve is in a normally open state (a normally open shutoff valve) at 802, that is, the high-pressure shutoff valve changes from an open state at 802 to a closed state at 808 when the pneumatic system operates at 807. In the electric drive fracturing device shown in FIG. 9, the high-pressure shutoff valve is in a normally closed state (a normally closed shutoff valve) at 908, that is, the high-pressure shutoff valve changes from an open state at 902 to a closed state at 908 when the pneumatic system does not operate at 907. A person skilled in the art may select a design based on an actual requirement.

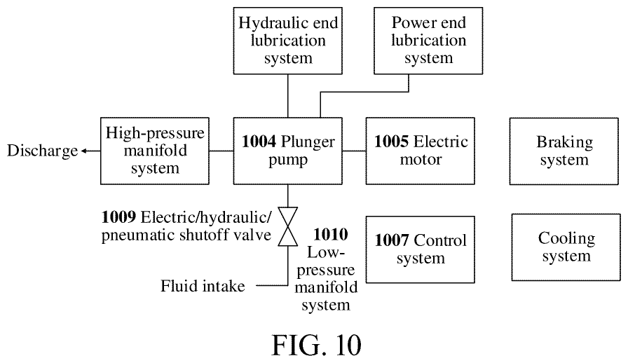

FIG. 10 is a schematic block diagram of an electric drive fracturing device according to Embodiment II of the present invention. As shown in FIG. 10, in Embodiment II, a brake execution component is a shutoff valve 1009 arranged in a low-pressure manifold system 1010. The shutoff valve 1009 may be a butterfly valve, a ball valve, or another shutoff valve. The shutoff valve 1009 may be closed and opened electrically, hydraulically, or pneumatically.

Specifically, when a braking action needs to be performed, the control system 1007 controls, after receiving the brake signal transmitted by the brake trigger component, the brake execution component (a shutoff valve 1009) to perform a braking action to stop the plunger pump 1004. It should be supplemented that the control system 1007 may further control the electric motor 1005 to stop power output after receiving the brake signal transmitted by the brake trigger component. Specifically, an electric motor 1005 driving the plunger pump 1004 stops power output. In this case, the plunger pump 1004 and the electric motor 1005 run by inertia, and at the same time, the shutoff valve 1009 starts to operate after receiving the brake signal. The shutoff valve 1009 is closed, so that the plunger pump 1004 no longer has external liquid supply. The plunger pump 1004 generates a negative pressure during inertia movement. The negative pressure may cause the plunger pump 1004 to brake and stop, and reversely brake the electric motor 1005. After receiving a shutdown feedback, the control system 1007 disables brake command output. In the electric drive fracturing device in Embodiment II, a shutoff valve 1009 is arranged on the low-pressure manifold system 1010, so that a braking effect may be achieved on the one hand, and the external liquid supply may be cut off on the other hand, thereby avoiding a waste of liquid.

Similar to Embodiment I, the shutoff valve 1009 arranged in the low-pressure manifold system 1010 may be set to a normally open state or a normally closed state, which is not limited in the present invention. A person skilled in the art may select a design based on an actual requirement. The manner of closing and opening the shutoff valve (electrically, hydraulically, or pneumatically) is similar to that in Embodiment I, and details are not described herein again.

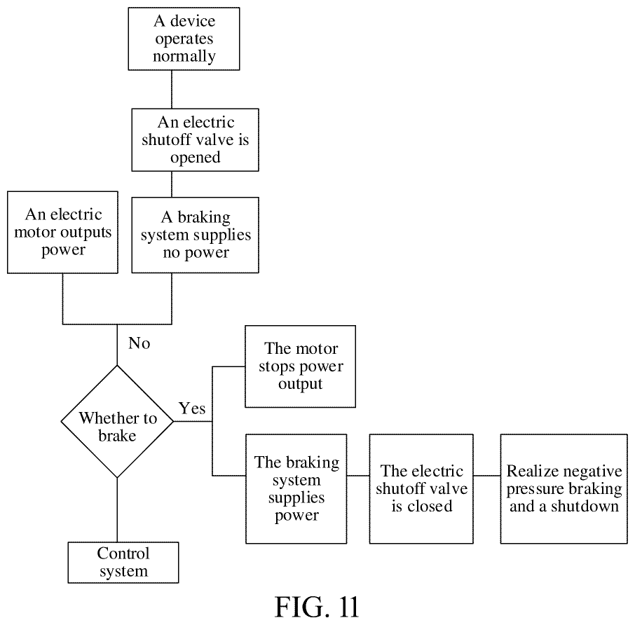

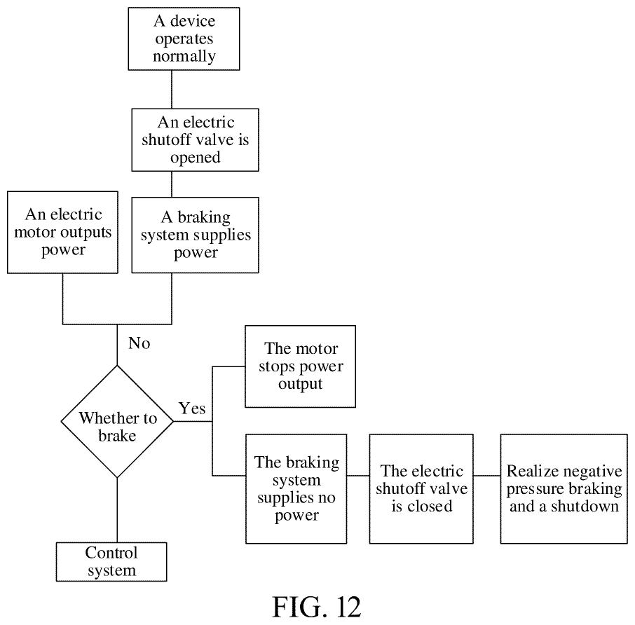

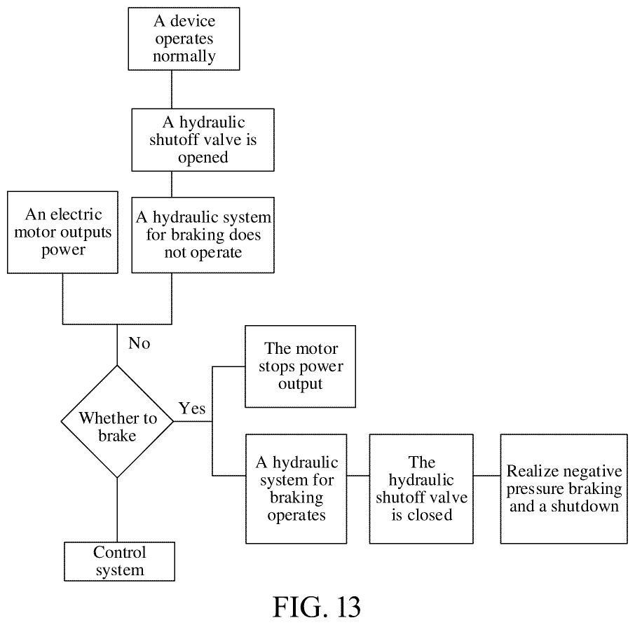

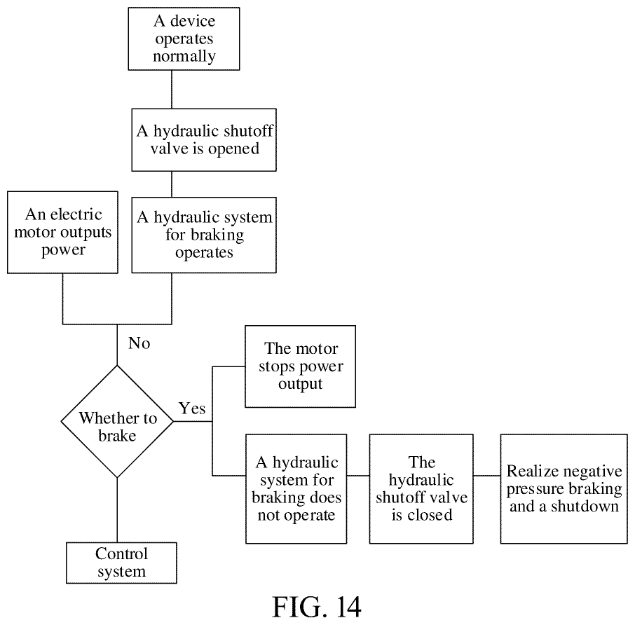

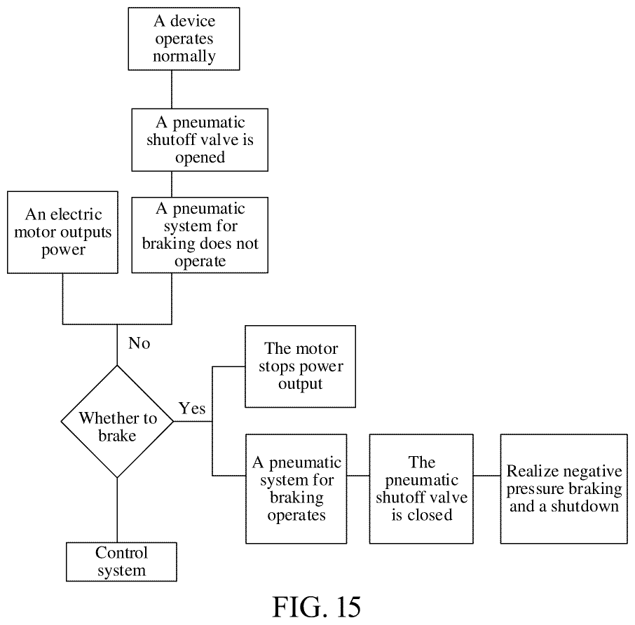

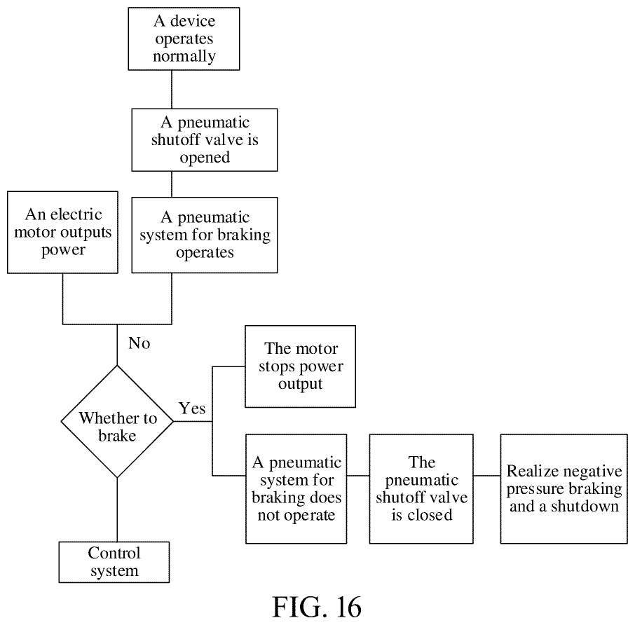

FIG. 11 is a first operating principle diagram of an electric drive fracturing device according to Embodiment II of the present invention, and FIG. 12 is a second operating principle diagram of an electric drive fracturing device according to Embodiment II of the present invention. FIG. 11 shows an operating principle diagram of an electric drive shutoff valve (a normally open shutoff valve) in a normally open state, and FIG. 12 shows an operating principle diagram of an electric drive shutoff valve (a normally closed shutoff valve) in a normally closed state. FIG. 13 is a third operating principle diagram of an electric drive fracturing device according to Embodiment II of the present invention, and FIG. 14 is a fourth operating principle diagram of an electric drive fracturing device according to Embodiment II of the present invention. FIG. 13 shows an operating principle diagram of a hydraulic drive shutoff valve in a normally open state, and FIG. 14 shows an operating principle diagram of a hydraulic drive shutoff valve in a normally closed state. FIG. 15 is a fifth operating principle diagram of an electric drive fracturing device according to Embodiment II of the present invention, and FIG. 16 is a sixth operating principle diagram of an electric drive fracturing device according to Embodiment II of the present invention. FIG. 15 shows an operating principle diagram of a pneumatic drive shutoff valve in a normally open state, and FIG. 16 shows an operating principle diagram of a pneumatic drive shutoff valve in a normally closed state.

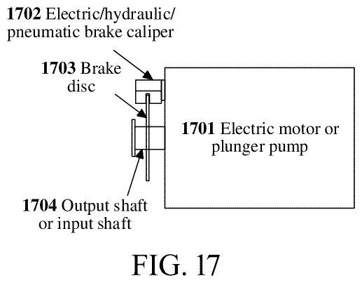

FIG. 17 is a schematic diagram of a brake execution component according to Embodiment III of the present invention. In this embodiment, the brake execution component includes a brake caliper 1702 and a brake disc 1703, and the brake disc 1703 is arranged on an output shaft 1704 of the electric motor or an input shaft 1704 of the plunger pump. In other words, a braking function is implemented by braking the brake disc 1703 through the brake caliper 1702. The brake caliper 1702 may be driven electrically, hydraulically, or pneumatically. For example, brake calipers 1702 and brake discs 1703 adopted on reduction gearbox systems of a diesel engine and a turbine engine in the related art may be used.

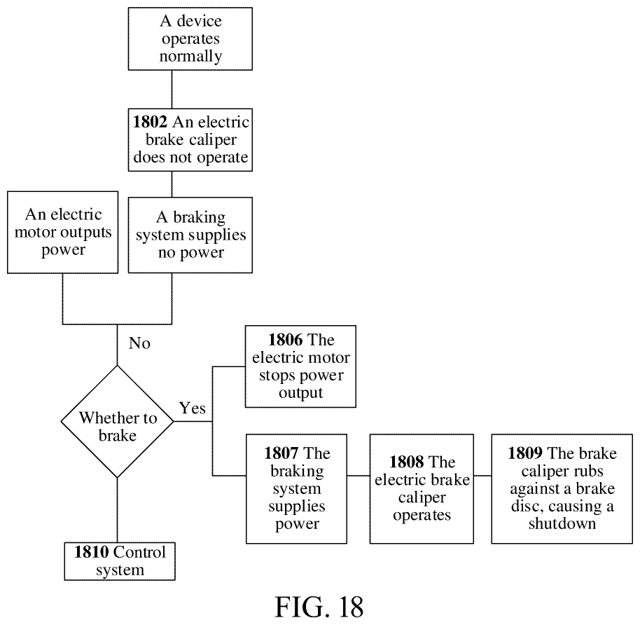

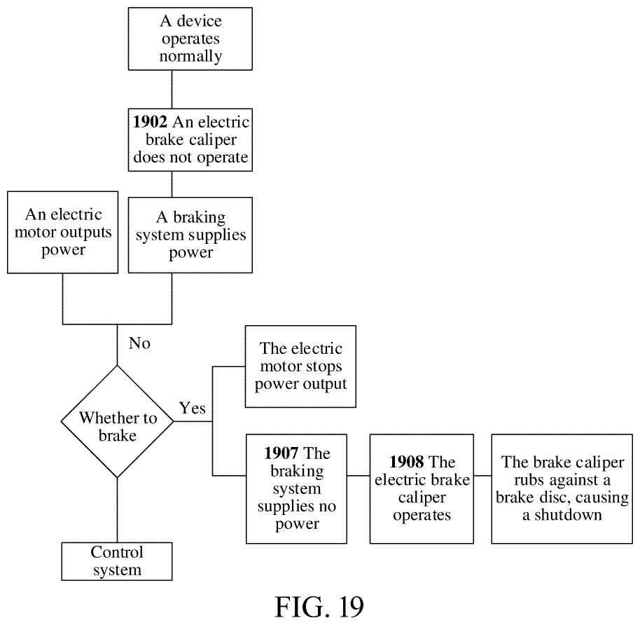

FIG. 18 is a first operating principle diagram of an electric drive fracturing device according to Embodiment III of the present invention, and FIG. 19 is a second operating principle diagram of an electric drive fracturing device according to Embodiment III of the present invention. When a brake caliper is driven electrically (an electric brake caliper), a power source may be provided by an internal power supply of the electric drive fracturing device body or by an external power supply. When a braking action needs to be performed, the control system 1810 controls, after receiving the brake signal transmitted by the brake trigger component, the brake execution component (the brake caliper and a brake disc) to perform a braking action to stop the plunger pump. It should be supplemented that the control system 1810 may further control the electric motor to stop power output at 1806 after receiving the brake signal transmitted by the brake trigger component. Specifically, an electric motor driving the plunger pump stops power output at 1806, the brake caliper operates at 1808 to clamp and rub the brake disc to realize braking at 1809, and the control system 1810 disables brake command output after receiving a shutdown feedback.

A difference between the electric drive fracturing devices shown in FIG. 18 and FIG. 19 is that in the electric drive fracturing device shown in FIG. 18, the brake caliper is a normally open brake caliper, that is, the brake caliper changes from an open state at 1802 to a clamped state at 1808 when power is supplied at 1807. In the electric drive fracturing device shown in FIG. 19, the brake caliper is a normally closed brake caliper, that is, the brake caliper changes from an open state at 1902 to a clamped state at 1908 when no power is supplied at 1907. A person skilled in the art may select a design based on an actual requirement.

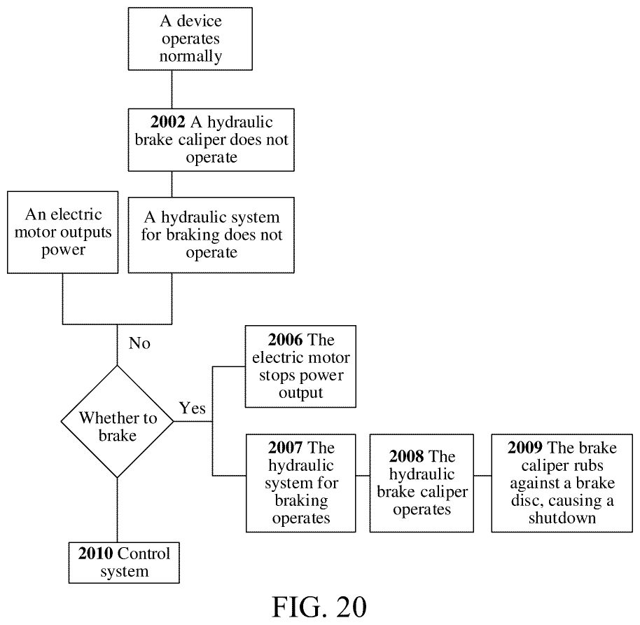

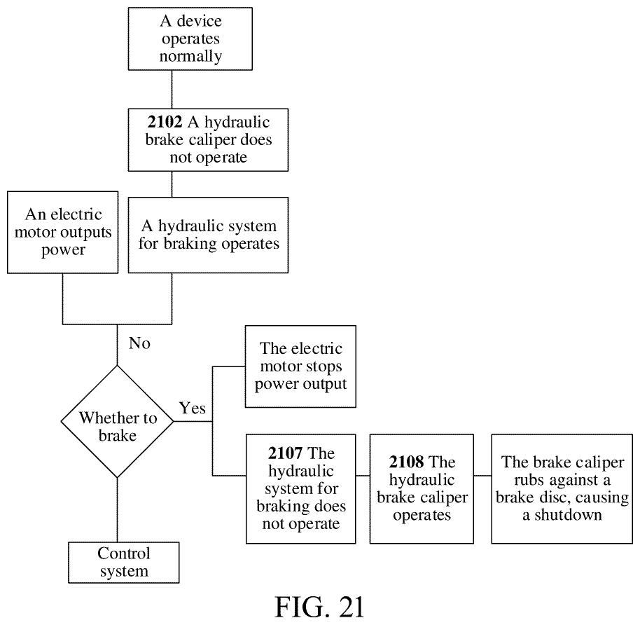

FIG. 20 is a third operating principle diagram of an electric drive fracturing device according to Embodiment III of the present invention, and FIG. 21 is a fourth operating principle diagram of an electric drive fracturing device according to Embodiment III of the present invention. When a brake caliper is driven hydraulically (a hydraulic brake caliper), hydraulic power may come from a hydraulic system (a power end lubrication system) mounted in the electric drive fracturing device body, or may come from a hydraulic system outside the electric drive fracturing device, and the hydraulic power may be cut off or restored through a valve (an electric valve, a hydraulic valve, or a pneumatic valve). When a braking action needs to be performed, the control system 2010 controls, after receiving the brake signal transmitted by the brake trigger component, the brake execution component (the brake caliper and a brake disc) to perform a braking action to stop the plunger pump. It should be supplemented that the control system 2010 may further control the electric motor to stop power output at 2006 after receiving the brake signal transmitted by the brake trigger component. Specifically, an electric motor driving the plunger pump stops power output at 2006, the brake caliper operates at 2008 to clamp and rub the brake disc to realize braking at 2009, and the control system 2010 disables brake command output after receiving a shutdown feedback.

A difference between the electric drive fracturing devices shown in FIG. 20 and FIG. 21 is that in the electric drive fracturing device shown in FIG. 20, the brake caliper is a normally open brake caliper, that is, the brake caliper changes from an open state at 2002 to a clamped state at 2008 when the hydraulic system operates at 2007. In the electric drive fracturing device shown in FIG. 21, the brake caliper is a normally closed brake caliper, that is, the brake caliper changes from an open state at 2102 to a clamped state at 2108 when the hydraulic system does not operate at 2107. A person skilled in the art may select a design based on an actual requirement.

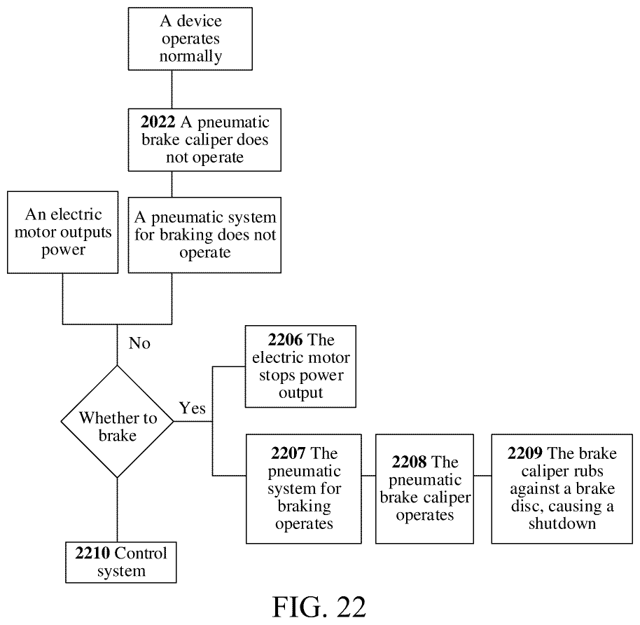

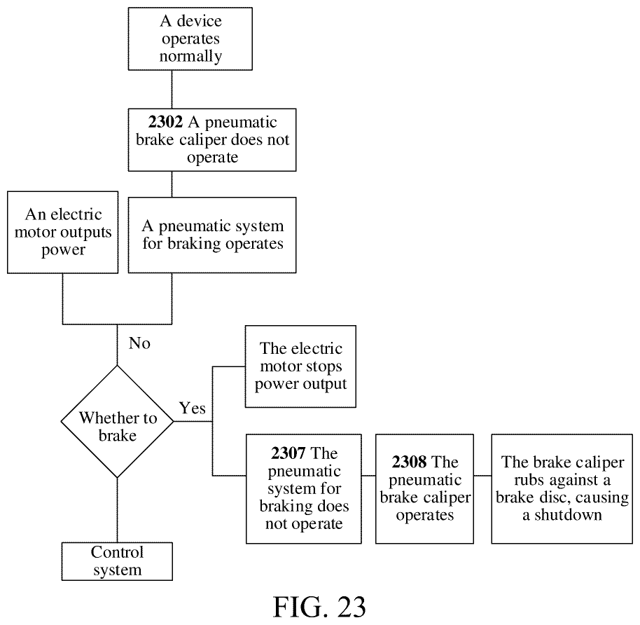

FIG. 22 is a fifth operating principle diagram of an electric drive fracturing device according to Embodiment III of the present invention, and FIG. 23 is a sixth operating principle diagram of an electric drive fracturing device according to Embodiment III of the present invention. When a brake caliper is driven pneumatically (a pneumatic brake caliper), pneumatic power may come from a pneumatic system mounted in the electric drive fracturing device body, or may come from a pneumatic system outside the electric drive fracturing device, and the pneumatic power may be cut off or restored through a valve (an electric valve, a hydraulic valve, or a pneumatic valve). When a braking action needs to be performed, the control system 2210 controls, after receiving the brake signal transmitted by the brake trigger component, the brake execution component (the brake caliper and a brake disc) to perform a braking action to stop the plunger pump. It should be supplemented that the control system 2210 may further control the electric motor to stop power output at 2206 after receiving the brake signal transmitted by the brake trigger component. Specifically, an electric motor driving the plunger pump stops power output at 2206, the brake caliper operates to clamp at 2208 and rub the brake disc to realize braking at 2209, and the control system 2210 disables brake command output after receiving a shutdown feedback.

A difference between the electric drive fracturing devices shown in FIG. 22 and FIG. 23 is that in the electric drive fracturing device shown in FIG. 22, the brake caliper is a normally open brake caliper, that is, the brake caliper changes from an open state at 2202 to a clamped state at 2208 when the pneumatic system operates at 2207. In the electric drive fracturing device shown in FIG. 23, the brake caliper is a normally closed brake caliper, that is, the brake caliper changes from an open state at 2302 to a clamped state at 2308 when the pneumatic system does not operate at 2307. A person skilled in the art may select a design based on an actual requirement.

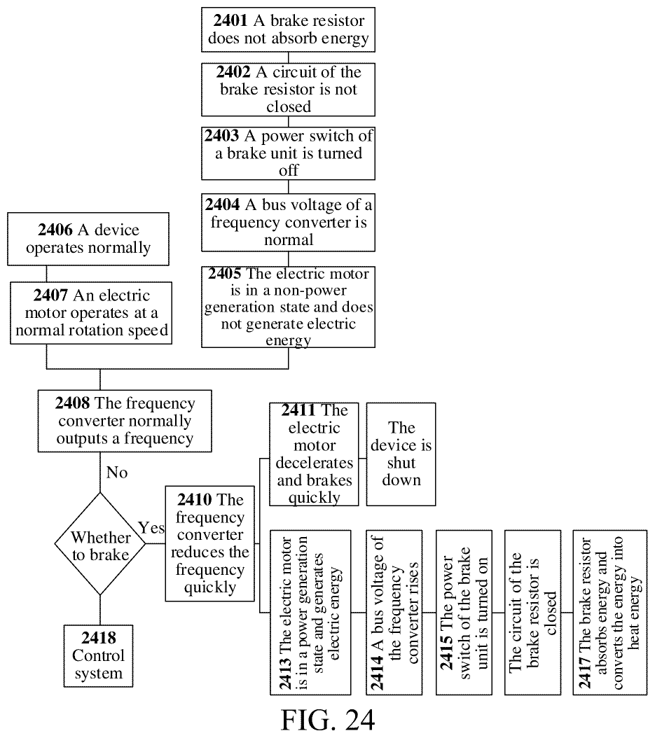

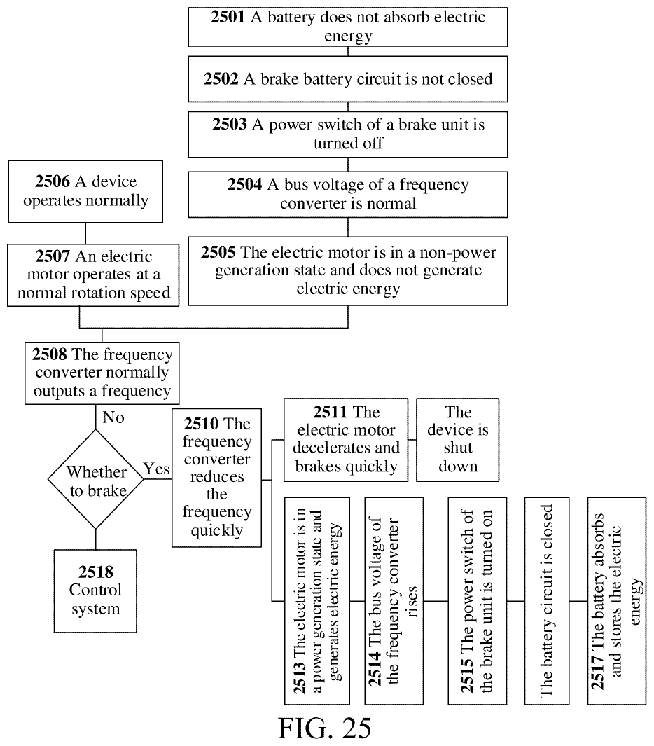

FIG. 24 is a first operating principle diagram of an electric drive fracturing device according to Embodiment IV of the present invention, and FIG. 25 is a second operating principle diagram of an electric drive fracturing device according to Embodiment IV of the present invention. In this embodiment, a brake execution component is a frequency converter. The frequency converter may be an electric drive fracturing device, may also be integrated into an electric motor, and may also be an external frequency converter. The frequency converter is used as a power control device that controls an AC electric motor by changing an operating power supply frequency of a motor. The principle of using a frequency converter to control an electric motor to brake belongs to the related art, and details are not described herein again.

In an example shown in FIG. 24, a brake resistor is arranged inside or outside the frequency converter. When braking is not needed, the frequency converter outputs a frequency normally at 2408. In this case, the electric motor outputs a rotation speed normally at 2407, the electric drive fracturing device operates normally at 2406, the electric motor is in a non-power generation state and does not generate electric energy at 2405, a DC bus voltage of a rectifier circuit system of the frequency converter is normal at 2404, a power switch of a brake unit is turned off at 2403, a circuit of the brake resistor is open at 2402, and the brake resistor does not absorb energy at 2401.

When a braking action needs to be performed, the control system 2418 transmits the brake signal to the frequency converter, and the frequency converter controls the electric motor to stop power output. Specifically, the frequency converter performs a braking action to reduce the frequency of the electric motor at 2410. The electric motor reduces the frequency, and decelerates and brakes quickly at 2411. The electric motor is in a power generation state and generates electric energy at 2413, and the DC bus voltage of the rectifier circuit system of the frequency converter rises at 2414. When the DC bus voltage rises to a set voltage value, the power switch of the brake unit is turned on at 2415, the electric energy is converted into heat of the brake resistor through consumption by the brake resistor at 2417, and the heat is released to the outside, so that the frequency converter finally controls braking, and the control system 2418 disables brake command output after receiving a shutdown feedback.

In an example shown in FIG. 25, a brake battery is arranged inside or outside the frequency converter. When braking is not needed, the frequency converter outputs a frequency normally at 2508. In this case, the electric motor outputs a rotation speed normally at 2507, the electric drive fracturing device operates normally at 2506, the electric motor is in a non-power generation state and does not generate electric energy at 2505, a DC bus voltage of a rectifier circuit system of the frequency converter is normal at 2504, a power switch of a brake unit is turned off at 2503, a circuit of the brake battery is open at 2502, and the brake battery does not absorb energy at 2501.

When a braking action needs to be performed, the control system 2518 transmits the brake signal to the frequency converter, and the frequency converter controls the electric motor to stop power output. Specifically, the frequency converter performs a braking action to reduce the frequency of the electric motor at 2510. The electric motor reduces the frequency, and decelerates and brakes quickly at 2511. The electric motor is in a power generation state and generates electric energy at 2513, and the DC bus voltage of the rectifier circuit system of the frequency converter rises at 2514. When the DC bus voltage rises to a set voltage value, the power switch of the brake unit is turned on at 2515, the circuit system charges the brake battery, the battery absorbs and stores the electric energy at 2517, consumes the brake energy, and converts the brake energy into electric energy, and the control system 2518 disables brake command output after receiving a shutdown feedback, so that the frequency converter finally controls braking and realizes recycling of braking energy.

It should be supplemented that the brake execution components in Embodiment I to Embodiment IV above may be used in combination. In other words, the brake execution component in the present invention may include one or more of a high-pressure shutoff valve arranged on the high-pressure manifold system, a shutoff valve arranged on the low-pressure manifold system, a brake caliper, a brake disc, and a frequency converter. It should be noted that when the frequency converter is used in combination with another kind of brake execution component, the braking effect needs to be set to a synchronous state.

Based on the above, in the present invention, a braking system is arranged in the electric drive fracturing device, so that rapid braking of the electric drive fracturing device can be implemented, and emergency braking can be performed immediately when a problem such as bursting of a high-pressure manifold system occurs on site, to avoid greater safety hazards and reduce environmental pollution and material waste. Further, through a frequency converter provided with a brake battery, it is also possible to recycle and utilize the braking energy while achieving braking.

What is claimed is:

1. An electric drive fracturing device, comprising an electric drive fracturing device body and a brake, wherein the electric drive fracturing device body comprises an electric motor, a plunger pump, a first manifold, a second manifold, and a controller, and the brake comprises a brake trigger component and a brake execution component; and the brake trigger component and the brake execution component are both electrically connected to the controller, the brake trigger component transmits a brake signal to the controller, and after receiving the brake signal transmitted by the brake trigger component, the controller controls the brake execution component to perform a braking action to stop the plunger pump.

2. The electric drive fracturing device according to claim 1, wherein the brake execution component is a shutoff valve arranged in the first manifold.

3. The electric drive fracturing device according to claim 2, wherein the shutoff valve is electrically, hydraulically, or pneumatically closed and opened, and the shutoff valve is configured to be closed after receiving the brake signal.

4. The electric drive fracturing device according to claim 3, wherein the shutoff valve is in a normally open state or a normally closed state.

5. The electric drive fracturing device according to claim 1, wherein the brake execution component is a shutoff valve arranged in the second manifold.

6. The electric drive fracturing device according to claim 5, wherein the shutoff valve is electrically, hydraulically, or pneumatically closed and opened, and the shutoff valve is configured to be closed after receiving the brake signal.

7. The electric drive fracturing device according to claim 6, wherein the shutoff valve is in a normally open state or a normally closed state.

8. The electric drive fracturing device according to claim 1, wherein the brake execution component is a brake caliper and a brake disc, and the brake disc is arranged on an output shaft of the electric motor or an input shaft of the plunger pump.

9. The electric drive fracturing device according to claim 8, wherein the brake caliper is driven electrically, hydraulically, or pneumatically, and the brake caliper is configured to clamp and rub the brake disc after receiving the brake signal.

10. The electric drive fracturing device according to claim 9, wherein the brake caliper is a normally open brake caliper or a normally closed brake caliper.

11. The electric drive fracturing device according to claim 1, wherein the controller further controls the electric motor to stop power output after receiving the brake signal transmitted by the brake trigger component.

12. The electric drive fracturing device according to claim 1, wherein the brake execution component is a frequency converter, and a brake battery or a brake resistor is arranged inside or outside the frequency converter.

13. The electric drive fracturing device according to claim 12, wherein the controller transmits the brake signal to the frequency converter after receiving the brake signal transmitted by the brake trigger component, the frequency converter controls the electric motor to stop power output after receiving the brake signal, and charges the brake battery, or the brake resistor absorbs energy and converts the energy into heat energy.

14. The electric drive fracturing device according to claim 1, wherein the brake execution component comprises one or more of a first shutoff valve arranged in the first manifold, a second shutoff valve arranged in the second manifold, a brake caliper, a brake disc, and a frequency converter.

15. The electric drive fracturing device according to claim 1, wherein the brake trigger component comprises a pressure sensor arranged in the first manifold or the plunger pump, and the pressure sensor is configured to perform real-time detection on a fluid pressure at a discharge end of the plunger pump.

16. The electric drive fracturing device according to claim 1, wherein the brake trigger component comprises a camera, and the camera is configured to perform real-time detection on images of the plunger pump and the first manifold.

17. The electric drive fracturing device according to claim 15, wherein the brake trigger component transmits the brake signal to the controller when the fluid pressure exceeds a set threshold.

18. The electric drive fracturing device according to claim 16, wherein the brake trigger component transmits the brake signal to the controller when a puncture occurs in the plunger pump or the first manifold.

19. The electric drive fracturing device according to claim 1, wherein the electric drive fracturing device body further comprises a hydraulic end lubrication system, a power end lubrication system, and a cooling system.

20. A braking method for an electric drive fracturing device, applied to the electric drive fracturing device according to claim 1, the braking method comprising:
performing, by the brake trigger component, real-time detection on a fluid pressure at a discharge end of the plunger pump and/or images of the plunger pump and the first manifold;
transmitting a brake signal to the controller when the fluid pressure exceeds a set threshold or when a puncture occurs in the plunger pump or the first manifold; and
controlling, by the controller after receiving the brake signal transmitted by the brake trigger component, the brake execution component to perform a braking action to stop the plunger pump.
